(19) United States
(12) Patent Application Publication
(10) Pub. No.: US 2018/0047045 A1
(43) Pub. Date: Feb. 15, 2018

(54) SYSTEM AND METHOD FOR HOTEL REWARDS PROGRAM

(71) Applicant: Bipin Gokalbhai Bhakta, Roswell, NM (US)

(72) Inventor: Bipin Gokalbhai Bhakta, Roswell, NM (US)

(21) Appl. No.: 15/236,214

(22) Filed: Aug. 12, 2016

(51) Int. Cl. G06Q 30/02; G06Q 10/02

(52) U.S. Cl. CPC G06Q 30/0226; G06Q 10/02

(57) ABSTRACT

The invention described herein is a method and system for hotel rewards where a guest makes a reservation or checks in to a hotel location; where a reward option is calculated and presented to guest after making the reservation or upon check-in; where the guest stays at least one night at the hotel location; where the guest checks out of the hotel location using at least one of a counter staffed by a hotel clerk, a kiosk staffed by a hotel clerk, and a desk staffed by a hotel clerk; and where the selected reward option is collected by the guest from the hotel clerk. there is no minimum number of nights stayed required by the guest with the hotel chain in any one location, but the guest must preferably check-in and stay at least one night to be eligible for the minimum reward option available.

### BRIEF DESCRIPTION OF THE DRAWINGS

FIG. 1 is a flow diagram for a SYSTEM AND METHOD FOR HOTEL REWARDS PROGRAM according to a preferred embodiment of the present invention.

FIG. 2 is a flow diagram for a SYSTEM AND METHOD FOR HOTEL REWARDS PROGRAM according to an alternate embodiment of the present invention.

### DETAILED DESCRIPTION OF THE INVENTION

The following description of the preferred embodiments of the invention is intended to enable someone skilled in the prior art to make and use this invention, but is not intended to limit the invention to these preferred embodiments.

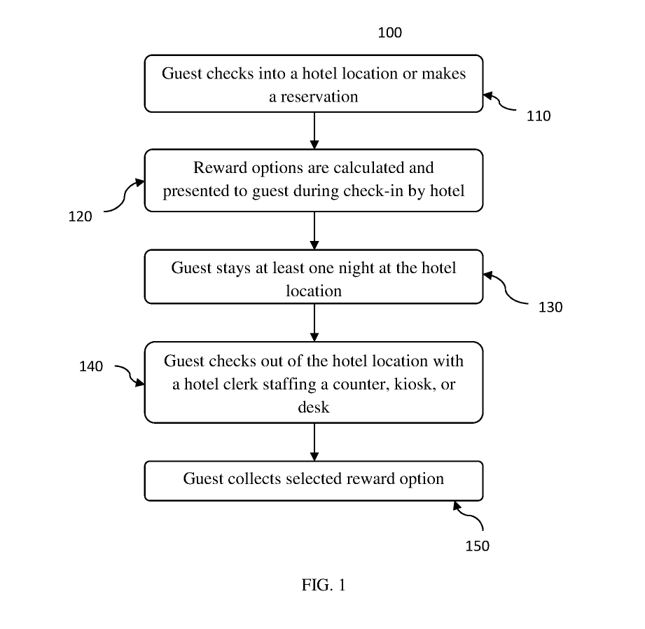

Now referring to FIG. 1, the invention described herein is a method and system for hotel rewards 100 where a guest makes a reservation or checks in to a hotel location 110; where a reward option is calculated and presented to guest after making the reservation or upon check-in 120; where the guest stays at least one night at the hotel location 130; where the guest checks out of the hotel location 140 using at least one of a counter staffed by a hotel clerk, a kiosk staffed by a hotel clerk, and a desk staffed by a hotel clerk; and where the selected reward option is collected by the guest from the hotel clerk 150. Alternately preferably, the hotel location is part of a hotel chain with multiple locations.

According to the preferred embodiment, there is no minimum number of nights stayed required by the guest with the hotel chain in any one location, but the guest must preferably check-in 120 and stay at least one night 130 to be eligible for the minimum reward option available. The longer the guest stays with the hotel location at any one time, the greater the reward option calculated and available upon check-in 120. The hotel clerk will preferably calculate and present the available reward options to the guest upon the guest's check-in with the hotel clerk 120. The guest then chooses which reward option to accept. The guest will then collect the chosen reward option during check-out with the hotel clerk 150 after their stay 140.

The reward options available to the guest preferably include, but are not limited to, gift cards to various third party business merchants or cash back reward. Other typical reward options not enumerated herein may be considered, such as discounts on future stays at the hotel location. The reward options are preferably calculated when the guest checks in, or makes their reservation, at the specific hotel location and collected when guest checks out with the hotel clerk staffing the counter, kiosk, or desk. The reward options are preferably calculated based upon the number of nights stayed with the hotel location at one time. The guest will preferably choose which reward option presented to them during check-in to collect at check-out, and the hotel clerk will give the guest the chosen reward option.

Alternately preferably, the guest will choose the reward option through the hotel location's internet website after being presented with the available reward options earned for their stay when making their reservation, or during check-in, by the hotel clerk staffing the counter, kiosk, or desk. After the guest's stay at the hotel location, if the guest chooses to collect their reward option through the hotel location's internet website, the selected reward option will be mailed to the guest to the address provided to the hotel location. Preferably, the guest does not need to be a member of a hotel rewards program to select and collect the guest's calculated earned reward option through the hotel location's internet website.

If multiple guests are staying in one room at the hotel location, preferably the selected reward option available at checkout may be redeemed by only one of the multiple guests staying in that room. When the guest party checks in to the hotel location, the hotel location clerk will make the earned reward options available to whichever guest is designated to accept the reward option.

The earned reward option is preferably not tied to an account holder that paid to reserve the room or to compensate the hotel location for the night or nights stayed. Also, the earned reward option is preferably independent of any credit card used when making the reservation or during check-in, so any guest that actually stayed at least one night at the hotel location may collect the selected reward option. For example, the guest may use a company's credit card to reserve and/or pay for a stay at a hotel location during a business trip, but individually take advantage of the rewards system by collecting the selected reward option. Additionally, if a guest's company makes the reservation on behalf of the guest, the individual guest will earn the reward for staying at the hotel location instead of the company.

In an alternate embodiment, the hotel location may be part of a hotel chain where multiple locations are located throughout the United States or the World. A guest may make a reservation, or check-in to any of the hotel locations within the hotel chain to be eligible to receive a reward option.

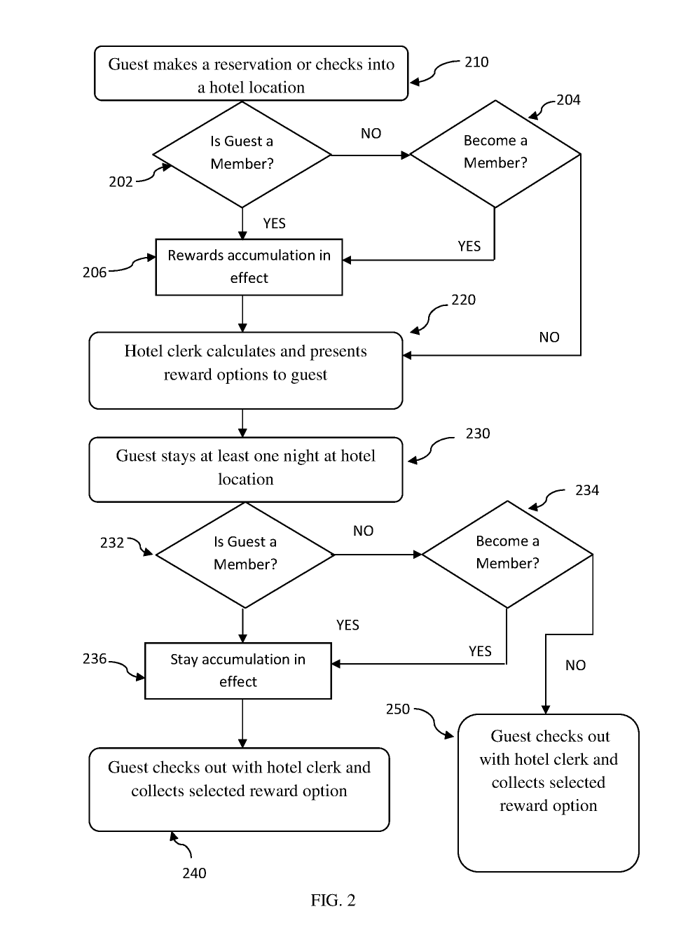

In an alternate embodiment as shown in FIG. 2, the guest will preferably sign up and register with the hotel location, or a hotel chain the hotel location is a part of, as a member of a rewards program associated with the hotel location. The guest will preferably register as a member of the rewards program at any time, including at the time of making a reservation with the hotel location, during check-in of their stay at the hotel location, during checkout after staying with the hotel location, or at any time in between.

As shown in FIG. 2, the alternate embodiment, when the guest makes a reservation or checks into the hotel location 210, a search will be performed to determine if the guest is a member 202 of the rewards program. If the guest is not a member, then the guest will be asked if they want to become a member 204. If the guest does not want to become a member, then a reward option will be calculated and presented to the guest 220 upon check-in with a hotel clerk. However, if the guest is a member, then previous stays at hotel locations within the hotel chain will be accumulated 206 with the present stay to calculate the available reward options 220.

Whether the guest is a member or not, the guest will then stay at least one night at the hotel location 230. When the guest completes their stay and checks out of the hotel location with the hotel clerk staffing the counter, kiosk, or desk, the hotel clerk will determine if the guest is a member of the rewards program 232. If the guest is a member, then the selected reward option based on previous accumulated stays 236 and the current stay will be collected by the guest 240. However, if the guest is not a member, then the guest will be asked if they would like to become a member 234. If the guest chooses not to become a member, the guest will collect the reward option earned for that specific stay at the hotel location 250. However, if the guest decides to become a member, then the guest's information will be entered. Then, the hotel clerk staffing the counter, kiosk, or desk will give the guest the option to collect the selected reward option for staying at the hotel location or to save the stay to accumulate with a future stay with the hotel location. If the hotel location is part of a hotel chain, then the future stay will preferably accumulate with any hotel location within the hotel chain.

When the member guest finishes their stay at the specific hotel location and checks out with the hotel clerk, the selected reward option is preferably only collected by the member guest. The member guest will preferably then decide to immediately collect the selected reward option or to save the selected reward option to accumulate with a future stay. If the guest decides not to collect the selected reward option upon checkout, their stay with the hotel location and the rewards earned based on that stay is preferably logged and recorded with the hotel location by the hotel clerk. Multiple stays by the member guest will accumulate with the all previous stays with various hotel locations within the hotel chain.

After completing a subsequent stay at any specific hotel location within the hotel chain, the member guest will preferably have a larger earned reward options calculated and presented to them by the hotel clerk when making their next reservation or upon check-in of their next stay. During check-in, or when making the reservation, at a subsequent stay, the hotel clerk staffing the counter, kiosk, or desk will preferably look up the member guest's previously logged and recorded stays. All of the member guest's accumulated nights stayed will preferably be recalculated to determine the larger earned reward options available to the member guest. The member guest will then preferably choose which of the larger earned reward options to collect upon checkout with the hotel location checkout clerk. Alternately preferably, the member guest may again decide not to redeem the larger earned reward options upon checkout and let the accumulated earned reward options continue to accumulate. The accumulated nights stayed will again be logged and recorded for future accumulation of reward options.

Preferably, all hotel locations within the hotel chain are in communication with the other hotel locations within the hotel chain. This way, the member guest's previously logged and recorded stays at specific hotel locations within the hotel chain will be tracked and accumulated for larger earned reward options.

We claim:

1. A method and system for hotel rewards wherein a guest makes a reservation or checks in to a hotel location; wherein a reward option is calculated and presented to said guest during check-in; wherein said guest stays at least one night at said hotel location; wherein said guest checks out of said hotel location using at least one of a counter staffed by a hotel clerk, a kiosk staffed by a hotel clerk, and a desk staffed by a hotel clerk; and wherein a selected reward option is collected by said guest upon checkout by said hotel clerk.

2. The method and system for hotel rewards of claim 1 wherein said reward option further comprises at least one of a gift card that can be redeemed by a third party business.

3. The method and system for hotel rewards of claim 1 wherein said reward option further comprises at least one discounted future night stay at any hotel location within a hotel chain.

4. The method and system for hotel rewards of claim 1 wherein said reward option further comprises a specific amount of cash.

5. The method and system for hotel rewards of claim 1 wherein said guest may choose to redeem said reward option on an internet website.

6. The method and system for hotel rewards of claim 1 wherein said at least one reward option is issued to said guest who stayed at said hotel location, and not to a holder of an account that paid for said at least one night's stay.

7. The method and system for hotel rewards of claim 1 wherein any one guest of a party who stays at said hotel location is eligible to receive said at least one reward option upon checkout.

8. The method and system for hotel rewards of claim 1 wherein said hotel clerk provides multiple reward options available to said guest calculated based on a number of nights stayed at said hotel location.

9. The method and system for hotel rewards of claim 8 wherein said guest chooses at least one of said available reward options to receive.

10. The method and system for hotel rewards of claim 1 wherein said guest registers for a membership system with a hotel chain.

11. The method and system for hotel rewards of claim 10 wherein only said guest member is eligible to collect said reward option upon checkout.

12. The method and system for hotel rewards of claim 1 wherein the longer said guest stays at said hotel location the greater the at least one reward option is available upon checkout.
